(19) United States
(12) Patent Application Publication
(10) Pub. No.: US 2017/0174900 A1
(43) Pub. Date: Jun. 22, 2017

(54) ENERGY CURABLE COMPOSITIONS

(71) Applicant: DIC IMAGING PRODUCTS USA LLC, Oak Creek, WI (US)

(72) Inventors: Russell ANDERSON, Milwaukee, WI (US); Shingo KUSANO, Kawaguchi Saitama (JP); Kazunari KAWAI, Toda-shi, Saitama (JP)

(73) Assignee: DIC IMAGING PRODUCTS USA LLC, Oak Creek, WI (US)

(21) Appl. No.: 15/039,203

(22) PCT Filed: Dec. 5, 2014
(86) PCT No.: PCT/US14/68752

§ 371 Date: May 25, 2016

Related U.S. Application Data
(60) Provisional application No. 61/916,441, filed on Dec. 16, 2013.

(51) Int. Cl. C09D 4/00; B05D 3/06; E04F 15/10; C09D 7/12

(52) U.S. Cl. CPC C09D 4/00; C09D 7/1241; B05D 3/067; E04F 15/10

(57) ABSTRACT

The present invention provides an energy curable coating composition comprising a carboxylic acid functional acrylate monomer, a polyester acrylate oligomer and at least one further oligomer. Furthermore the present also provides a process for preparing a coated substrate, in particular a flooring substrate which comprises applying an energy curable coating composition onto a substrate and curing the composition. The composition provides improved flow and leveling characteristics and a coating with high degree of scratch resistance.

### CROSS REFERENCE TO RELATED APPLICATIONS

This application claims priority to U.S. Provisional Patent Application Ser. No. 61/916,441 filed Dec. 16, 2013. All the applications are incorporated herein by reference in the entirety and for all purposes.

### FIELD OF THE INVENTION

The present invention relates to energy curable compositions which are particularly useful as floor coatings. The present also provides a process for preparing a coated substrate, in particular a flooring substrate, which comprises applying an energy curable coating composition onto a substrate and curing the composition.

### BACKGROUND OF THE INVENTION

U.S. Pat. No. 5,571,570 is directed to UV cured coatings that demonstrate high gloss, improved scratch resistance and improved abrasion resistance which contain acrylated aliphatic urethane that can be coated onto plastic or metal parts.

U.S. Pat. No. 6,087,413 is directed to an ultraviolet curable clearcoat for use in coating articles that contain acrylated aliphatic urethane.

U.S. Pat. No. 6,420,451 describes curable compositions suitable for coating plastic ophthalmic lenses which contain a first acrylated aliphatic urethane and a second acrylated aliphatic urethane.

U.S. Pat. No. 5,637,292 provides a UV curable human nail coating containing a aliphatic waterborne urethane.

US2009/0301561 is directed to a radiation curable liquid coating composition that includes at least one aliphatic urethane acrylic oligomer and at least one acrylate monomer for coating a substrate such as a thin film PV module surface.

US2009/0011122 provides an ink mold coating composition wherein the composition has an acrylic base which can include a combination of monofunctional or multifunctional acrylate and/or methacrylate compounds, such as a hexafunctional aliphatic urethane acrylate.

U.S. Pat. No. 6,110,988 is directed to a UV curable hard coat composition which also contains an acrylated aliphatic urethane which improves abrasion resistance.

US2009/0297724 is directed to UV curable coating compositions including a unique blend of aliphatic urethane acrylate resins which are used to coat molded plastic articles such as a clear polycarbonate lens.

US2011/0123732 describes UV curable polymers for use in intermediate transfer belts used for electrostatic devices.

U.S. Pat. No. 6,998,425 is directed to UV curable acrylate coating compositions which contain at least two polyfunctional acrylate derivatives such as a hexafunctional urethane acrylate and a polyester acrylate oligomer.

US20080257216 describes UV curable coating compositions which include new urethane (meth) acrylates and their methods of preparation.

US2008/0138531is directed to a UV radiation curable primer coating composition which demonstrates improved curing time.

JPH06136668 is directed to an anti-flouling flooring material.

U.S. Pat. No. 5,128,387 describes a radiation curable coating composition for metal surfaces such as an aluminum beverage can which contains an acidic adhesion promoter and a mixture of oligomeric components. The acidic adhesion promoter is used in a relatively small amount but it appears to be necessary to achieve adequate adhesion to the metal surface. Generally from about 1 to 2% by weight of acidic adhesion monomer is adequate for a monomer such as betacarboxyethyl acrylate.

U.S. Pat. No. 7,317,061 discloses a family of novel multifunctional acrylate ionomeric resins which are water dispersible and have a built-in photoinitiator. These water-dispersible ionomeric compositions cure under standard UV-cure conditions, to yield tack-free coatings without the addition of traditional photoinitators.

Floor coating compositions are required to provide the necessary flow and leveling characteristics such that they provide a smooth and uniform coating over a flooring substrate. Furthermore floor coatings are required to have a high degree of scratch resistance.

Typically, these coating compositions use solvents to improve the flow and leveling characteristics which may include organic or inorganic solvents such that alcohols, esters and water.

However, the use of organic solvents results in compositions with an increased amount of volatile organic compounds (VOC's) and associated odor. Furthermore the use of solvents also increases the length of time required for the coating to dry due to solvent evaporation.

Coating compositions may also contain additives such as silicone leveling aids and defoamers that can improve the flow and leveling characteristics.

However, the addition of such additive materials can prevent the resultant coatings from being “overcoated” given that adhesion of the overcoat is compromised.

Furthermore such additive materials may introduce other defects in the coating surface such as “orange peel” and “fish eyes”.

Consequently, it would be advantageous to provide a low odor composition that is essentially solvent and additive free and thus contains reduced amounts of VOC's and wherein the length of time for the coating to dry is minimized.

It has been now been found that energy curable compositions comprising one or more carboxylic acid functional acrylate monomers, a polyester acrylate oligomer and one or more further oligomers, which are typically considered incompatible and are thus not utilized together, provide compositions that exhibit improved flow and leveling in combination with a high degree of scratch resistance when coated onto a substrate.

### SUMMARY OF THE INVENTION

The present invention provides an energy curable coating composition comprising
a) carboxylic acid functional acrylate monomer
b) a polyester acrylate oligomer and
c) at least one further oligomer.

The present also provides a process for preparing a coated substrate which comprises
a) applying the energy curable coating composition onto a substrate and
b) curing the composition.

These and other objects, advantages, and features of the invention will become apparent to those persons skilled in the art upon reading the details of the methods and formulations as more fully described below.

### DETAILED DESCRIPTION OF THE INVENTION

The energy curable compositions according to the present invention can be applied to provide a coating on any suitable substrate such as substrates used for walls, roofs and floors or the like but are advantageously used to coat a flooring substrate.

The compositions can also be used to coat sectional substrates that when pieced together produce the completed wall, roof or floor e.g. tiles.

The energy curable compositions when applied to a substrate are capable of flowing quickly over the substrate surface with a level uniformity.

This is particularly useful when coating flooring sections and results in a uniform appearance when the flooring sections are placed together to provide a completed flooring surface wherein the sectioning is not apparent.

Furthermore the energy curable compositions advantageously provide a high level of durability and scratch resistance and thus long lasting protection of the substrate surface.

Finally, the monomers and oligomers within the energy curable composition are less prone to separation over time, which reduces the requirement for vigorous mixing before use and are thus more user friendly.

The energy curable coating composition contains one or more carboxylic acid functional acrylate monomers. Preferably carboxylic acid functional acrylate monomers are selected from monoacryloxyethylsuccinate, monoacryloxyethyl-hexahydrophthalate, monoacryloxyethyl-methylhexahydrophthalate or β-carboxyethylacrylate.

The composition preferably comprises 1-50% by weight of the carboxylic acid functional acrylate monomer and more preferably 5-40% by weight of the carboxylic acid functional acrylate monomer.

The composition also includes a polyester acrylate oligomer which is preferably a hyperbranched polyester acrylate oligomer and most preferably the polyester acrylate oligomer is amine modified, chlorinated and/or fatty acid modified. Advantageously, the polyester acrylate oligomer is hexafunctional.

The composition preferably comprises 1-50% by weight of the polyester acrylate oligomer and more preferably 5-25% by weight of the polyester acrylate oligomer.

Finally the composition also includes a further oligomer which is preferably a urethane acrylate oligomer. However, other types of oligomers could be used such as epoxy oligomers, allylic oligomers, acrylic oligomers, polybutadiene, polyether, melamine and/or soybean oil. Advantageously, the urethane acrylate oligomer is aliphatic and/or hexafunctional.

The composition preferably comprises 1-50% by weight of the further oligomer and more preferably 5-25% by weight of the further oligomer.

The composition may also contain other multi-functional or mono-functional monomers. Such monomers include include tetrahydrofurfuryl acrylate, cyclohexyl acrylate, n-hexyl acrylate, 2-ethoxyethyl acrylate, isodecyl acrylate, 2-methoxyethyl acrylate, 2-(2-ethoxyethoxy)ethyl acrylate, stearyl acrylate, lauryl acrylate, octyl acrylate, 2-phenoxyethyl acrylate, glycidyl acrylate, isobornyl acrylate, benzyl acrylate, tridecyl acrylate, caprolactone acrylate, ethoxylated nonylphenol acrylate, and polypropylene glycol acrylate, triethylene glycol diacrylate, ethylene glycol diacrylate, 1,3-butylene glycol diacrylate, 1,4-butanediol diacrylate, diethylene glycol diacrylate, hexanediol diacrylate (HDODA), neopenyl glycol diacrylate, dipropylene glycol diacrylate (DPGDA), tripropylene glycol diacrylate, ethoxylated bisphenol A diacrylate, propoxylated neopentyl glycol diacrylate, pentaerythritol tetraacrylate, pentaerythritol triacrylate, trimethylolpropane triacrylate, ethoxylated trimethylolpropane triacrylate (TMPEOTA), ditrimethylolpropane tetraacrylate and ethoxylated pentaerythritol tetraacrylate.

Wherein the composition comprises other multi-functional or mono-functional monomers these are typically present in the amount of 1-50% by weight, preferably between 35-45% by weight.

Furthermore the composition may include one or more photoinitiators. Such photoinitiators may be selected from the group consisting of benzophenone and its derivatives, benzoin, a-methylbenzoin, a-phenylbenzoin, a-allylbenzoin, a-benzylbenzoin, benzyl dimethyl ketal, benzoin methyl ether, benzoin ethyl ether, benzoin n-butyl ether; acetopheone and its derivatives such as 2-hydroxy-2-methyl-1-phenyl-1-propan-1-one (HMPP), 1-hydroxycyclohexyl phenyl ketone (CPK), 2-methyl-1-[4-(methylthio)phenyl]-2-(4-morpholinyl)-1-propanone, 2-benzyl-2-2(dimethylamino)-1-[4-(4-morpholinyl)phenyl]-1-butanone, along with phenyl glyoxylic acid methyl ester and diphenyl trimethoxy benzyl phosphine oxide (TPO).

Wherein the composition comprises at least one photoinitiator these are typically present in the amount of 1-15% by weight, preferably between 5-10% by weight.

The composition may also contain surface treatment agents such as reactive and non-reactive acrylic polymers, waxes such as polypropylene, carnauba, polytetrafluoroethylene (PTFE), and polyethylene.

Wherein the composition comprises at least one surface treatment agent these are typically present in the amount of 1-5% by weight, preferably between 2-4% by weight.

Finally the composition may include stabilizers, which can be selected from phenothiozene, butylated hydroxytoluene (BHT) and its derivatives, hydroquinone and its derivatives such as 4-methoxy phenol, methylhydroquinone and N-nitrosophenylhydroxylamine.

Wherein the composition comprises at least one stabilizer the stabilizer is typically present in the amount of 0.05-1% by weight, preferably between 0.1-0.5% by weight.

The energy curable compositions according to the present invention are preferably used without colorants, but alternatively the compositions may include colorants. Suitable colorants may include, organic or inorganic pigments and dyes.

The composition may contain a single organic pigment or a combination of pigments, such as for instance Pigment Yellow Numbers 12, 13, 14, 17, 74, 83, 114, 126, 127, 174, 188; Pigment Red Numbers 2, 22, 23, 48:1, 48:2, 52, 52:1, 53, 57:1, 112, 122, 166, 170, 184, 202, 266, 269; Pigment Orange Numbers 5, 16, 34, 36; Pigment Blue Numbers 15, 15:3, 15:4; Pigment Violet Numbers 3, 23, 27; and/or Pigment Green Number 7.

Inorganic pigments may be selected from iron oxides, titanium dioxides, chromium oxides, ferric ammonium ferrocyanides, ferric oxide blacks, Pigment Black Number 7 and/or Pigment White Numbers 6 and 7.

The dyes include but are not limited to azo dyes, anthraquinone dyes, xanthene dyes, azine dyes, combinations thereof and the like.

Other additives such as waxes, ammonia, defoamers, dispersants, stabilizers, silicones, rheological modifiers, plasticizers and the like may also be incorporated into the composition. However, the compositions contain less than 1% by weight of silicone additives e.g. between 0.1-0.5% by weight but are preferably free of silicone additives.

Finally the compositions preferably contain less than 10% by weight of solvents, more preferably less than 5% by weight and are most preferably solvent free.

The energy curable compositions according to the present invention can be applied to any suitable substrate that can be coated or printed thereon having acceptable adhesion and performance properties such as paper or a polymeric material.

Preferably, the substrate is a non-metallic substrate and may be selected from any suitable material such as wood, bamboo, terrazzo, marble, slate, ceramic tile, concrete, linoleum, roll vinyl, rubber, cork or laminate flooring. Advantageously the flooring substrate is a vinyl composition tile (VCT).

The coatings may be applied to the substrate by any suitable means such as a paint roller or as a spray and typically the applied coating is between 0.1 to 5 mm thick such as 0.5-2.5 mm thick and has a smooth uniform appearance.

Whilst the preferred use of the compositions is to coat a flooring substrate the compositions could also be suitably modified, in particular in terms of viscosity and rheology for use in other applications, for example screen printing, lithographic printing, flexographic printing, gravure printing and/or spray printing.

Preferably, the compositions have a viscosity between 100-300cps at 25° C. when measured with Brookfield DVII+ cone and plate viscometer equipped with spindle CPE-40 and most preferably between 150-250cps.

Finally the compositions may be cured using any curing means, such as electron beam, infra-red, LED, but are preferably cured using UV radiation.

### EXAMPLES

The following examples illustrate specific aspects of the present invention and are not intended to limit the scope thereof in any respect and should not be so construed.

### Example 1

### Composition According to the Present Invention

The following composition as shown in table 1 was prepared and the viscosity was 220 cps at 25° C. when measured with Brookfield DVII+cone and plate viscometer equipped with spindle CPE-40.

TABLE 1

| Material | Type | % |
|---|---|---|
| Hexafunctional aliphatic urethane | urethane acrylate oligomer | 22.0 |
| oligomer (CN 9026, Sartomer) | | |
| Hexafunctional polyester | polyester acrylate oligomer | 19.5 |
| oligomer (CN 2303, Sartomer) | | |
| 1,6 hexanediol diacrylate | multi-functional monomer | 23.9 |
| Ethoxylated (3 mol) | multi-functional monomer | 14.0 |
| trimethylolpropane diacrylate | | |
| Monoacryloxyethyl succinate | carboxylic acid functional | 9.0 |
| (Photomer 4703, IGM) | monomer | |
| Methylbenzylformate | photoinitiator | 5.0 |
| 1-hydroxycyclohexyl phenyl ketone | photoinitiator | 4.0 |
| LG-99 (Estron Chemical) | surface treatment additive | 1.5 |
| Polyethylene dispersion | surface treatment additive | 1.0 |
| (CC7610, Lubrizol) | | |
| Butylated hydroxytoluene | stabilizer | 0.1 |
| Total | | 100.0 |

The composition was applied to a VCT tile using a 9 inch wide, 5/16 nap microfiber roller from Benjamin Moore (product number 722). The composition thickness was 1.5 mil when measured using a Nordson-Gardner wet film thickness gage (WF-790010). The composition was allowed to settle for 5 minutes and then cured with a portable UV curing apparatus.

Uniformity was then determined by measuring 60° gloss with a BYK micro-Tri-gloss meter. The resulting gloss readings in 5 different areas showed results of 85±5 at 60°. A maximum gloss range of 10 gloss units between readings has been found to be uniform in appearance.

### Example 2

### Composition According to the Present Invention

The following composition as shown in table 2 was prepared and the viscosity was 220 cps at 25° C. when measured with Brookfield DVII+cone and plate viscometer equipped with spindle CPE-40.

TABLE 2

| Material | Type | % |
|---|---|---|
| Hexafunctional aliphatic urethane | urethane acrylate oligomer | 10.0 |
| oligomer (Ebecryl 1290, Allnex) | | |
| Hexafunctional polyester | polyester acrylate oligomer | 10.0 |
| oligomer (CN 2303, Sartomer) | | |
| 1,6 hexanediol diacrylate Ethoxylated | multi-functional monomer | 20.2 |
| (3 mol) | multi-functional monomer | 15.0 |
| trimethylolpropane diacrylate | | |
| Monoacryloxyethyl succinate | carboxylic acid functional | 35.0 |
| (Photomer 4703, IGM) | monomer | |
| Oligo[2-hydroxy-2-methyl-1-[4- | photoinitiator | 5.5 |
| (methylvinyl)phenyl]propanone] | | |
| Diphenyl (2,4,6-trimehtylbenzoyl) | photoinitiator | 1.5 |
| phosphine oxide | | |
| Bis(2,4,6-trimetylbonzoyl)- | photoinitiator | 0.2 |
| phenylphosphine oxide | | |
| LG-99 (Estron Chemical) | surface treatment additive | 1.5 |
| Polyethylene dispersion (CC7610, | surface treatment additive | 1.0 |
| Lubrizol) | | |
| Butylated hydroxytoluene | stabilizer | 0.1 |
| Total | | 100.0 |

The composition was applied to a VCT tile using a 9 inch wide, 5/16 nap microfiber roller from Benjamin Moore (product number 722). The composition thickness was 1.5 mil when measured using a Nordson-Gardner wet film thickness gage (WF-790010). The composition was allowed to settle for 5 minutes and then cured with a portable UV curing apparatus.

Uniformity was then determined by measuring 60° gloss with a BYK micro-Tri-gloss meter. The resulting gloss readings in 5 different areas showed results of 80±5 at 60°. A maximum gloss range of 10 gloss units between readings has found to be uniform in appearance.

### Comparative Example 3

### Not According to the Invention

A commercial material from DIC Imaging, FC-121, which does not contain a carboxylic acid functional acrylate monomer, was tested in the field utilizing a 9 inch wide, 5/16 nap microfiber roller from Benjamin Moore (product number 722).

The wet film thickness when measured using a Nordson-Gardner wet film thickness gage (WF-790010) was 1.5 mil. The composition was allowed to settle for 5 minutes and then cured with a portable UV curing apparatus.

Uniformity was then determined by measuring 60° gloss with a BYK micro-Tri-gloss meter. The resulting gloss readings of 5 different areas showed readings of 70±15 at 60°. The gloss range of 30 gloss points is considered to be non-uniform.

### Example 4

### Coating Durability Testing

The following compositions shown in table 3 were deposited onto coated, white chart paper from BYK (PA-2827) with a #15 wire wound rod delivering a 1.5 mil coating. The coated sheet was then cured at 30 ft/min with a Bulldog curing unit from HID Ultraviolet equipped with a 200W/in medium pressure mercury bulb delivering a dose of 500 mJ/cm² UVA+UVB. The resulting coatings were measured for gloss using the BYK micro-tri-gloss at 60°. The coatings were then tested for scratch resistance using a 32 oz ball peen hammer equipped with 000 steel wool. The steel wool attached to the hammer was placed on the coating with the handle perpendicular to the film, pushed forward and back (1 double rub) 20 times and gloss measurements were obtained. This process was continued until a total of 100 cycles were completed.

TABLE 3

| | A | | | | |
|---|---|---|---|---|---|
| Formula | (comparative) | B | C | D | E |
| Aliphatic Hexacrylate | 22.0 | 22.0 | 22.0 | 22.0 | 22.0 |
| Urethane (CN 9026 | | | | | |
| Sartomer) | | | | | |
| Hyperbranched Polyester | 0 | 5.0 | 10.0 | 20.0 | 40.0 |
| Acrylate (CN 2303 | | | | | |
| Sartomer) | | | | | |
| 1,6 hexanediol diacrylate | 41.9 | 36.9 | 31.9 | 21.9 | 11.9 |
| (difunctional acrylate | | | | | |
| monomer) | | | | | |
| Ethoxylated (3 mol) | 15.5 | 15.5 | 15.5 | 15.5 | 15.5 |
| trimethylolpropane | | | | | |
| diacrylate (trifunctional | | | | | |
| acrylate monomer) | | | | | |
| Carboxylic acid functional | 10.0 | 10.0 | 10.0 | 10.0 | 10.0 |
| acrylate monomer | | | | | |
| (Photomer 4703 IGM) | | | | | |
| Methylbenzylformate | 5.0 | 5.0 | 5.0 | 5.0 | 5.0 |
| (photoinitiator) | | | | | |
| 1-hydroxycyclohexyl | 4.0 | 4.0 | 4.0 | 4.0 | 4.0 |
| phenyl ketone | | | | | |
| (photoinitiator) | | | | | |
| Surface additive | 1.5 | 1.5 | 1.5 | 1.5 | 1.5 |
| (LG-99 Estron Chemical) | | | | | |
| Butylated hydroxytoluene | 0.1 | 0.1 | 0.1 | 0.1 | 0.1 |
| (Stabilizer) | | | | | |
| Total | 100 | 100 | 100 | 100 | 100 |

TABLE 4

| | 60° Gloss Readings | | | | |
|---|---|---|---|---|---|
| Double Rubs | A | B | C | D | E |
| 0 | 93.8 | 92.8 | 92.0 | 92.3 | 92.0 |
| 20 | 80.2 | 79.8 | 79.4 | 82.0 | 83.0 |
| 40 | 72.7 | 78.0 | 83.0 | 79.0 | 81.1 |
| 60 | 70.4 | 80.1 | 81.1 | 78.1 | 80.0 |
| 80 | 70.2 | 77.4 | 78.5 | 77.0 | 79.3 |
| 100 | 65.2 | 77.0 | 79.0 | 78.0 | 78.6 |

Rub results are shown in table 4. Comparative example A shows a large drop in gloss points when rubbed with steel wool were compositions B-E comprising the hyperbranched polyester acrylate showed a small drop in gloss points indicating a much more scratch resistant and durable coating.

All references cited herein are herein incorporated by reference in their entirety for all purposes.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the invention.

1. An energy curable coating composition comprising
a) a carboxylic acid functional acrylate monomer
b) a polyester acrylate oligomer and
c) at least one further oligomer.

2. A composition according to claim 1 wherein the carboxylic acid functional acrylate monomer, is monoacryloxyethylsuccinate, monoacryloxyethyl-hexahydrophthalate, monoacryloxyethyl-methylhexahydrophthalate or β-carboxyethylacrylate.

3. A composition according to claim 1, wherein the polyester acrylate oligomer is a hyperbranched, amine modified, chlorinated and/or fatty acid modified.

4. A composition according to according to claim 3 wherein the polyester acrylate oligomer is a hyperbranched.

5. A composition according to claim 1, wherein the polyester acrylate oligomer is a hexafunctional polyester acrylate oligomer.

6. A composition according to claim 1, wherein the further oligomer is a urethane acrylate oligomer.

7. A composition according to claim 6 wherein the urethane acrylate oligomer is a hexafunctional aliphatic urethane acrylate oligomer.

8. A composition according to claim 1, comprising 1-50% by weight of the carboxylic acid functional acrylate monomer.

9. A composition according to claim 1, comprising 5-40% by weight of the carboxylic acid functional acrylate monomer.

10. A composition according to claim 1, comprising 1-50% by weight of the polyester acrylate oligomer.

11. A composition according to claim 1, comprising 5-25% by weight of the polyester acrylate oligomer.

12. A composition according to claim 1, comprising 1-50% by weight of the further oligomer.

13. A composition according to claim 1, comprising 5-25% by weight of the further oligomer.

14. A composition according to claim 1, further comprising a mono functional and/or a multi-functional monomer.

15. A composition according to claim 14 wherein the mono functional monomer and /or multifunctional is selected from the group consisting of tetrahydrofurfuryl acrylate, cyclohexyl acrylate, n-hexyl acrylate, 2-ethoxyethyl acrylate, isodecyl acrylate, 2-methoxyethyl acrylate, 2-(2-ethoxyethoxy)ethyl acrylate, stearyl acrylate, lauryl acrylate, octyl acrylate, 2-phenoxyethyl acrylate, glycidyl acrylate, isobornyl acrylate, benzyl acrylate, tridecyl acrylate, caprolactone acrylate, ethoxylated nonylphenol acrylate, and polypropylene glycol acrylate, triethylene glycol diacrylate, ethylene glycol diacrylate, 1,3-butylene glycol diacrylate, 1,4-butanediol diacrylate, diethylene glycol diacrylate, hexanediol diacrylate (HDODA), neopenyl glycol diacrylate, dipropylene glycol diacrylate (DPGDA), tripropylene glycol diacrylate, ethoxylated bisphenol A diacrylate, propoxylated neopentyl glycol diacrylate, pentaerythritol tetraacrylate, pentaerythritol triacrylate, trimethylolpropane triacrylate, ethoxylated trimethylolpropane triacrylate (TMPEOTA), ditrimethylolpropane tetraacrylate and ethoxylated pentaerythritol tetraacrylate.

16. A composition according claim 14, comprising 1-50% by weight of the mono functional and/or a multi-functional monomer.

17. A composition according claim 14, comprising 20-40% by weight of the mono functional and/or a multi-functional monomer.

18. A composition according to claim 1, further comprising a photoinitiator.

19. A composition according to claim 1, further comprising a surface treatment agent.

20. A composition according to claim 1, further comprising a stabilizer.

21. A process for preparing a coated substrate which comprises
a) applying the energy curable coating composition according to claim 1, onto a substrate and
b) curing the composition.

22. A process according to claim 21 wherein the substrate is a flooring substrate.

23. A process according to claim 21, wherein the applied coating is cured using UV radiation.

24. A coated substrate comprising a coating composition according to claim 1, cured thereon.

25. A coated substrate according to claim 24, wherein the substrate is a flooring substrate.

26. A coated substrate according to claim 24, wherein flooring substrate is a vinyl composition tile.
